(19) United States
(12) Patent Application Publication
(10) Pub. No.: US 2014/0305847 A1
(43) Pub. Date: Oct. 16, 2014

(54) DEVICE AND METHOD FOR COMBINING CARDS AND CARD SUPPORTS, FOR HANDLING CARDS AND/OR FOR SORTING CARDS FROM CARD HOLDERS

(71) Applicant: Heiner Kudrus, Eupen (BE)

(72) Inventor: Heiner Kudrus, Eupen (BE)

(73) Assignee: BOEWE SYSTEC GMBH, Augsburg (DE)

(21) Appl. No.: 14/357,309

(22) PCT Filed: Sep. 10, 2012
(86) PCT No.: PCT/DE2012/000898

§ 371 Date: May 9, 2014

(30) Foreign Application Priority Data
Nov. 11, 2011 (DE) 10 2011 118 190.7
Mar. 13, 2012 (DE) 10 2012 004 830.0

(51) Int. Cl. B07C 5/00; B65D 25/20

(52) U.S. Cl. CPC B07C 5/00; B65D 25/205
USPC 209/10; 206/459.1; 209/552

(57) ABSTRACT

A device and a method for sorting cards, has a card supply, a card output and an intermediate memory with addressable intermediate memory locations. A device for combining cards and card supports and/or for sorting and/or handling cards use a card-specific database containing information sorted according to types and styles of cards, and uses visual information and/or location information relating to assemblies of the card of at least one card type and/or a card style. The device has a reversible intermediate memory with at least one intermediate storage station. The database contains card-specific information relating to a stored card in the intermediate memory location, and a magazine for cards with at least one input and/or output and having a card memory having a plurality of card locations. The card locations relative to the input and/or output can be displaced by a drive.

The invention relates to an apparatus and a method for combining cards and card supports, for handling cards and/or for sorting cards. Likewise, the present invention relates to a card magazine.

Corresponding apparatuses are known, for example, from WO 2008/107839 A2, from WO 2004/039711 A1, from DE 10 2004 053 562 B4 and from U.S. Pat. No. 4,866,259, respectively. Thus, WO 2008/107839 A2 discloses an apparatus for combining cards and card supports in an application area, in which cards and card supports are united with one another by way of an industrial manipulator, with a card provisioning unit for supplying cards to the application area and with a card support channel for supplying card supports, which are generally present in the form of letters and the like, to the application area. In this connection, the cards in the card support channel are checked and electronically detected to the effect that a corresponding letter with the corresponding address is printed and can be supplied to the application area, in the card support channel, synchronously to the corresponding card. By means of a horizontal articulated arm robot as the manipulator, the cards are applied to the card supports in the application area, whereby the manipulator also sorts out defective cards to a separate stack; these must then be removed manually.

WO 2004/039711 A1 discloses a temporary storage unit or a card magazine, in which cards can be temporarily stored according to the FIFO principle.

U.S. Pat. No. 4,866,259 and DE 10 2004 053 562 B4, respectively, disclose apparatuses, in each instance, with which cards that are to be applied to card supports can be personalized. In this connection, these cards are provided not only with general data, such as a specific imprint of a company logo or the like, but also with personalized data, such as a personal photo of the user, the user name, or the like.

It is the task of the present invention to configure apparatuses of the stated type to be as compact as possible and to perform methods of the stated type on the most compact systems possible.

In connection with the present description, it should be emphasized that debit cards, credit cards or similar cards are particularly used as cards. Likewise, SIM cards or chips, particularly telephone chips, can accordingly be united, as cards, with card supports. In this regard, the term “card” in the present connection comprises planar, essentially inherently rigid bodies, which are not larger than 10 by 10 cm.

In practical experiments by the inventor, a reversible temporary storage unit has proven to be particularly advantageous, and this relates not only to feed errors of card supports that occur very rarely, but can occur as part of the process, but also to card support defects as such. Particularly, however, in the case of small series, the sorting processes of which might not be carried out automatically, a corresponding reversible temporary storage unit proves to be extremely advantageous.

These advantages can particularly be utilized if the temporary storage unit has addressable temporary storage locations, because then not only random but also targeted removal of cards situated in the temporary storage unit is possible. In this regard, it is possible that a card support is requested and made available by way of the card support channel for a card situated in the temporary storage unit, for example, thereby making it possible for incorrectly assigned cards, for example, or cards that were placed in the temporary storage unit because a related card support that was to be united with this card had to be sorted out during an interim inspection, because it was defective, can be transferred back into the overall process in rapid and operationally reliable manner.

Accordingly, the task stated initially is also solved by an apparatus for combining cards and card supports in an application area in which cards and card supports are united with one another, with a card provisioning unit for supplying cards to the application area, with a card support channel for supplying card supports to the application area, and with a temporary storage unit for temporarily storing at least two cards, wherein the apparatus is characterized in that the temporary storage unit has temporary storage locations that can be individually addressed. Particularly in deviation from WO 2004/039711 A1, which does not make such targeted removal possible, free access to the cards that are stored in the temporary storage unit is therefore possible, so that it is possible to react to possible disruptions in rapid and individual manner. It is understood that such an apparatus with addressable temporary storage locations is advantageous even independent of the use of a manipulator, whereby if applicable, the corresponding advantages can particularly be synergistically utilized in interplay with a manipulator.

On the other hand, such a card magazine with independently addressable card locations, utilized as a temporary storage unit, also proves to be advantageous independent of the other characteristics of the present invention. Accordingly, the task stated initially is also accomplished by a magazine for cards having at least one input and/or output and having a card storage unit having a plurality of card locations, the card locations of which are displaceable relative to the input and/or output, by means of a drive, which magazine is characterized in that an absolute or relative address is assigned to each of the card locations, and an actuator controls the drive until an addressed card location is disposed at the input and/or output. In this connection, it is understood—depending on the concrete implementation of the present invention—that the card locations are moved and the input and/or output remain(s) fixed in place, as disclosed in WO 2004/039711 A1, which brings about the advantage that flexible transport to the input and/or output is not necessary. On the other hand, it is possible to move the input and/or output, while the card locations remain fixed in place, which then requires corresponding flexible transport to and from the movable input and/or output. Likewise, it is possible that not only the input and/or output but also the card locations are moved, as long as there is a relative movement of the input and/or output with regard to the card locations. In this connection, it should also be emphasized that a magazine generally provides for essentially one-dimensional placement of the card locations, which are disposed linearly or one behind the other in the case of a stacked magazine, and on a closed track in the case of a circular magazine.

The actuator of the drive preferably has a signal input for indicating a card location address, so that a corresponding card location can be requested in simple and precise manner at the input and/or output, for input of a card into the card magazine or into the corresponding temporary storage unit or for output or removal of a card from the card magazine or from the corresponding temporary storage unit.

Precise and rapid provisioning of a desired card location takes place if the actuator has a signal output for indicating if a specific card location is disposed at the input and/or output. The latter can be, for example, the precise address, an identification of a card situated in the magazine at this address, or simply a binary signal, the latter when the desired card location address has been reached. Preferably, the indication at the signal output only occurs if the card location is also accessible by way of the input and/or output, so that in this manner, incorrect access can be restricted to a minimum, without any further measures.

Absolute addressing of the card locations can also be implemented in particularly simple manner if an address support that bears a clear address is assigned to each card location, and an address reader is provided in a spatially fixed relation to the drive, with the address supports moving past the drive as the card locations are moved.

If the drive comprises a reversal of direction, the access time can be restricted to a minimum, particularly in the case of circular magazines or card locations disposed in endless manner relative to one another. Furthermore, a reversal of direction also allows flexible use of the card magazine, while card locations disposed in endless manner relative to one another allow a great number of card locations in the card storage unit, also independent of this, in space-saving manner.

Preferably, the card magazine comprises a circular card storage unit with card holders disposed in circular manner, which allows a particularly compact construction and rapid movement sequences with correspondingly short access times. Cumulatively or alternatively to this, for corresponding reasons, the card storage unit with its card holders can have a one-piece basic body.

It is also advantageous if the card spaces of the magazine or of the storage unit are configured passively, in each instance, so that no construction space and weight needs to be expended for complex modules that are required for interaction with the cards that goes beyond purely mechanical storage. In this regard, the functionality of a mass storage unit, in particular of being able to store as many cards as possible with acceptable access times and output them again, can be implemented as optimally as possible by means of a passive configuration of the card spaces or of the storage unit. In particular, no feed lines, which must be transferred to a moving part in complicated manner, by means of sliding contacts or other interfaces, are required. Likewise, complicated contact locations or writing and reading devices do not have to be kept on hand at every card space; these again would cost construction space and thereby reduce the number of card spaces, and would contribute to the overall weight, which again has a negative influence on the access time.

In order to allow cards already provided with adhesive, which are subsequently supposed to be applied to a card support by means of the adhesive, to be stored in the card magazine or in a corresponding temporary storage unit, without the adhesive degenerating too much, each card location can have at least one card holder assigned to it, which has a recess and a holder edge that surrounds the recess at least on two sides, which edge comprises a card contact surface, so that adhesive can be present on the card in the area of the recess. It is understood that this characteristic is correspondingly advantageous even independent of the other characteristics of the present invention, in the case of a card magazine or a temporary storage unit.

Accordingly, the task stated initially is also accomplished by a method for combining cards and card supports in an application area, in which cards and card supports are united with one another in targeted manner, wherein any non-matching cards or cards to be handled separately are temporarily stored in a temporary storage unit, wherein the method is characterized in that the cards are removed from the temporary storage unit in targeted manner and united with a related card support.

In this connection, it is easily possible, in particular, that before targeted removal of a card from the temporary storage unit, a card support that corresponds to this card is made available in the application area, wherein this can easily also take place, if applicable, together with or after targeted removal of the card, insofar as a card situated in the temporary storage unit is selected, by way of corresponding programming, as a card to be applied at a specific point in time. The actual removal can then take place at a point in time when the card support and the card that are to be united with one another get into the application area in correspondingly synchronized manner.

In this regard, it is advantageous if each card support has a card support data set assigned to it and each card has a card data set assigned to it, and two card supports and cards to be united are first identified, and targeted removal from the temporary storage unit takes place when the identified card support is being supplied to the application area. In this manner, the method can be carried out in extremely effective manner.

As has already been explained above, the temporary storage unit can have temporary storage locations that can be reached directly and individually by the manipulator, so that targeted removal from these temporary storage locations is possible. Alternatively, it is also possible to deposit cards in stacked manner on corresponding temporary storage units, so that addressed and targeted removal is no longer possible, because ultimately, such stacks can be used according to the FILO principle. Instead of corresponding stacks, however, magazines can easily be used, whereby these can be stacked magazines, for example, which also work according to the FILO principle. Likewise, however, magazines such as those disclosed in WO 2004/039711 A1, for example, can also be used, in this regard. Depending on the concrete implementation of the present invention, these magazines can have addressable storage locations, so that here, too, targeted removal is possible, something that is not possible in the case of magazines with non-addressable storage locations as such, without individual card recognition.

Frequently, cards also have to be sorted. This happens, for example, in a separate work step and on a separate machine, before application to a card support, in which step cards of different types, for example, such as a personalized debit card and a non-personalized gift certificate card, for example, are alternately placed, in each instance, into a magazine, which is then passed to an application apparatus, so that the cards can be successively removed from this magazine and supplied to the application area. In this connection, it is not necessarily only the sequence of the cards that must be sorted, but rather possibly also the position of the card—in other words the front or back upward or a specific orientation in the card plane—that must be influenced in targeted manner. Corresponding sorting processes can also be necessary if accidents occur and a filled magazine falls down, for example, and is suddenly emptied. Even if multiple magazines are present at an application apparatus, sorting processes might become necessary, if, for example, gift certificate cards having different values are made available in one magazine, and personalized cards are made available in another magazine, whereby the personalized cards might also have to be sorted if they are supposed to be applied to letters that are to be sent to different countries or are sorted by postal code, for example.

A corresponding sorting apparatus for sorting cards, with a card provisioning unit and a card output unit, has a relatively compact construction if it comprises a temporary storage unit and an industrial manipulator, which takes cards from the card provisioning unit and puts then down at the card output unit, if necessary with use of the temporary storage unit.

In particular, also in the case of such an arrangement, however, also in the case of the aforementioned arrangements, the temporary storage unit can be utilized as a card provisioning unit. In this regard, the cards to be sorted or to be processed or handled some other way can also be applied to the temporary storage unit manually or some other way, and can be passed into the apparatus or into the process from there, for sorting or other processing or handling.

The task stated initially is also accomplished by a method for sorting cards, which is characterized in that the cards are removed from a card provisioning unit, for example by means of an industrial manipulator, and output, sorted, at a card output, wherein for sorting, the cards are temporarily stored in a temporary storage unit with independently addressable temporary storage locations.

In particular, it is also possible to output the cards to different output locations at the card output unit, for example to assign them to different magazines.

Accordingly, it is also advantageous if the card output unit comprises multiple output locations. Multiple output locations or a card output unit at different output locations particularly allows sorting by different card types, such as, for example, according to the presence of a magnetic strip and/or a chip, or kinds of cards, such as, for example whether they are debit cards or credit cards, chips, SIM cards or telephone chips, electronic memory cards or the like.

It is similarly advantageous for sorting apparatuses, as in the case of the apparatus mentioned above for combining cards and card supports, if a measurement station or a card processing station is provided, so that on the one hand, automatic recognition of the card or its orientation and, on the other hand, processing, such as personalization, in particular, is possible. It is true that a temporary storage unit, for example within reach of an industrial manipulator, already brings about very good sorting capacity and a compact construction. If one or more measurement stations or one or more card processing stations are situated within reach of the manipulator or of a corresponding conveying segment to the temporary storage unit or past the latter, especially many corresponding measures can be performed in a spatially very limited, therefore compact area, in compact manner.

In particular, it is possible, by way of measurement stations, to also administer a database accordingly, so that the sorted cards are also correspondingly recorded in a database. In this connection, the configuration of a magazine into which cards are sorted can particularly be recorded in the database, independent of whether data sets belonging to the cards, in each instance, are already assigned to the cards, or whether this must still be done, by way of corresponding measurement stations.

In practical experiments, a reversible temporary storage unit has also proven to be extremely advantageous in sorting apparatuses and sorting methods. Particularly in connection with small series, sorting procedures can be conducted automatically in this manner. These advantages can particularly be utilized if the temporary storage unit has addressable temporary storage locations, because then, not only random but rather targeted removal of cards situated in the temporary storage unit is possible.

Accordingly, the use of an independently addressable temporary storage location, in particular, is also advantageous, by means of which each individual card and each storage location of the temporary storage unit is very flexibly available for sorting procedures, particularly for a corresponding manipulator.

In this regard, also in the case of sorting procedures, cards can be advantageously removed from the temporary storage unit and output, in sorted manner, at a suitable location.

As was already explained above, the temporary storage unit can have temporary storage locations that can be reached directly and individually by the manipulator, so that targeted removal from these temporary storage locations is possible. Alternatively, it is also possible to put cards down, stacked, onto corresponding temporary storage units, so that addressed and targeted removal is no longer possible, because ultimately, such stacks can be utilized according to the FILO principle. Instead of corresponding stacks, however, magazines can easily be used, whereby these can be stacked magazines, for example, which also work according to the FILO principle. Likewise, however, magazines such as those disclosed in WO 2004/039711 A1, for example, can also be used, whereby preferably, an input and/or an output of the magazines, whether they are stacked magazines or circular magazines or another type of magazines, is/are disposed in the area of the manipulator, in each instance. Depending on the concrete implementation of the present sorting method and sorting apparatuses, these magazines can have independently addressable storage locations, so that here, too, targeted removal is possible, which is not possible in the case of magazines with non-addressable storage locations as such, without individual card recognition.

Accordingly, it is also advantageous if the removal from the temporary storage unit takes place by means of a manipulator of the sorting apparatus, whereby this manipulator, depending on the concrete implementation of the present invention, either moves to a temporary storage location directly, or picks a card up from or sets a card down at an input and/or output of a temporary storage unit.

In this regard, is it also advantageous, with regard to method management, if the manipulator sets down cards at different temporary storage locations and picks them up again there, as needed, and/or if the temporary storage unit comprises a magazine with an output, from which the manipulator can pick up a card, as needed, after it the magazine makes the corresponding card available at the output. All of this leads to extremely flexible method management, with a compact structure of the corresponding system.

In this regard, it should be emphasized that the explanations above and below with regard to apparatuses and methods with regard to the application of cards to card supports or with regard to handling of cards, particularly with reference to the different embodiments of the temporary storage units, can particularly be advantageously utilized also for methods and apparatuses for sorting of cards.

If a database contains not only card-specific data, sorted by card type and kind of card, which ultimately is already known from the state of the art, but also visual data and/or position data about modules of the card of at least one card type and/or one kind of card, then a card can be oriented in accordance with the desired default values, and output at a card output unit, if necessary in sorted manner, or applied to a card support, in rapid and operationally reliable manner, in distinction from the state of the art for apparatuses for combining cards and card supports and/or apparatuses for sorting and/or handling or cards, independent of the other characteristics of the present invention. This is particularly advantageous if cards are passed to the corresponding apparatus completely unsorted, for example lying on a table. In particular, however, correcting intervention can occur also in the case of incorrect orientations, which, although they occur extremely rarely, cannot be entirely precluded, even during a large order, so that the actual process that is working on the large order is not influenced or impaired, or only to an insignificant extent.

Preferably, the corresponding apparatuses comprise measurement stations by means of which data complementary to the visual data and/or position data about modules contained in the database can be measured on a corresponding card. In particular, these can be corresponding cameras that record such visual data. Likewise, scanners can also be used in this regard. Scanning devices or reading devices that respond when a corresponding module is situated in a position complementary to the reading device, for example, can be used for determining the position data of modules.

The task stated initially is also accomplished by an apparatus for combining cards and card supports and/or for sorting and/or handling cards, with a database that contains card-specific data sorted by card types and kinds of cards, which apparatus is characterized in that it has a reversible temporary storage unit with at least one temporary storage location, and that the database contains card-specific data about a card temporarily stored in the temporary storage unit. By means of such an apparatus, subsequent assignment of a card situated in the temporary storage unit to a card support can take place in compact manner, whereby—depending on the concrete implementation of this solution—a corresponding card support can be requested before, while or after the card is placed in the temporary storage unit. In this connection, it is particularly possible that a corresponding process controller removes a corresponding card from the temporary storage unit again, in targeted manner, on its own, and unites it with the related card support when the latter is accordingly made available. On the other hand, it is also possible that the card support channel has measurement stations that detect a specific card support as such, whereupon a corresponding card is then removed from the temporary storage unit in targeted manner, and united with corresponding card supports.

Preferably, the reversible temporary storage unit is addressable, which significantly facilitates the method management explained above, independent of whether only handling or, in contrast, sorting or application is involved, whereby this is even further facilitated if the temporary storage unit is independently addressable, so that targeted removal from the temporary storage unit can take place at any time and very rapidly.

Depending on the concrete requirements, an order for making a matching card support available can be issued before, while or after a related card has been placed in the temporary storage unit. This ultimately depends on when during the method sequence it can be determined that a card support matching a card is not available, for example if this support had to be sorted out subsequently, during an inspection, before uniting takes place.

In particular, the card support can be prepared in accordance with default values from a database, taking the card-specific data in the database into account, in each instance. Thus, for example, in the case of a personalized card, a correspondingly personalized letter can be produced, which is then united with the related card as a card support, which card, in turn, is temporarily stored in the temporary storage unit until the related card support has been prepared.

In a preferred embodiment of the method, a card can be removed from the temporary storage unit in targeted manner when a related card support is being supplied to the application area. Preferably, for this purpose, individual data of the card support are measured, for example by means of optical image detection and recognition of an address field or by means of reading a barcode, and the temporary storage location of the card, in each instance, is determined on the basis of the measurement values, from a database. Such method management is extremely flexible, because ultimately, corresponding card supports can also be introduced into the card support channel by hand. Because, on the one hand, the individual data of a card support situated at a specific location of the card support channel are known, if necessary by means of corresponding measurement or detection, alternatively, of course, targeted addressing of the corresponding temporary storage location can take place on the basis of these data.

It is understood that the characteristics of the solutions described above and in the claims, respectively, can also be combined in order to be able to implement the advantages cumulatively, accordingly. In particular, it should be emphasized that the solutions described above or in the claims in the case of a handling apparatus or in the case of a handling method, can be used also in the case of corresponding sorting and application apparatuses and methods. Likewise, the solutions described above or in the claims in the case of sorting apparatuses and methods can also be used, to corresponding advantage, in the case of application apparatuses and methods.

Further advantages, goals, and properties of the present invention will be explained using the following description of exemplary embodiments, which are particularly also shown in the attached drawing. The drawing shows:

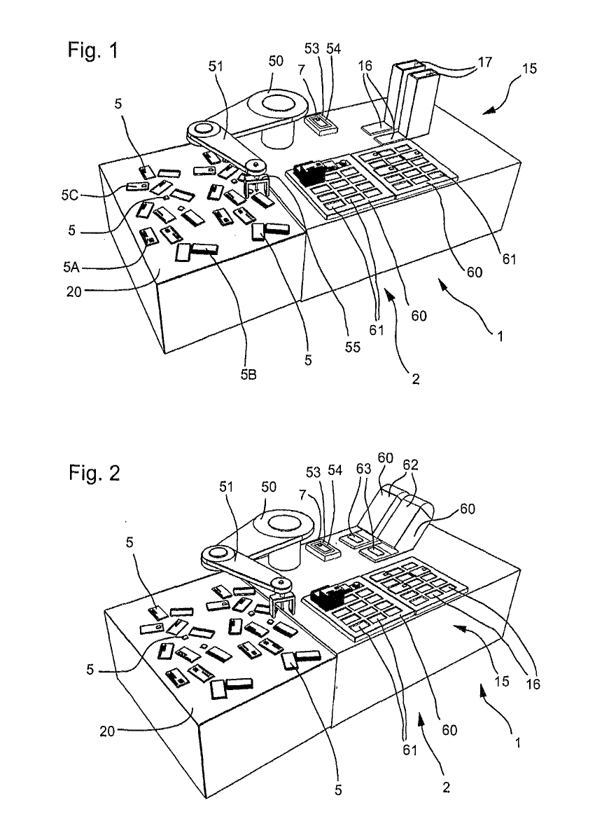

FIG. 1 a first sorting apparatus with a manipulator in a perspective schematic view;

FIG. 2 a second sorting apparatus with a manipulator in a perspective schematic view;

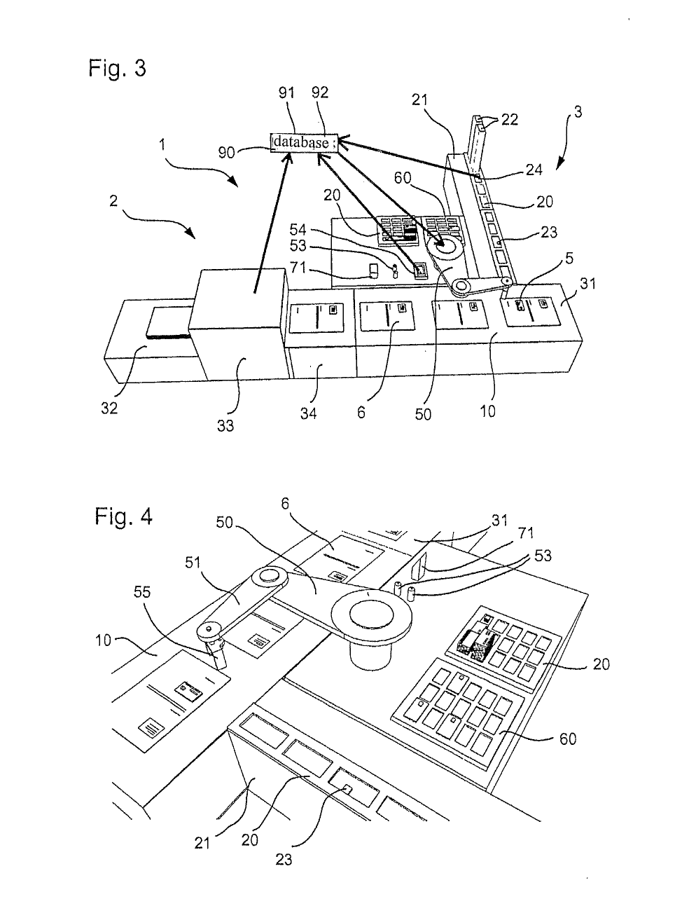

FIG. 3 an application station with a manipulator and a card channel for card provisioning in a perspective schematic view, as well as a schematic representation of a database;

FIG. 4 the arrangement according to FIG. 3 in a detail view from a different perspective;

FIG. 5 a further application station with a card channel as a card provisioning unit as well as a conventional applicator and an independently addressable magazine as a temporary storage unit;

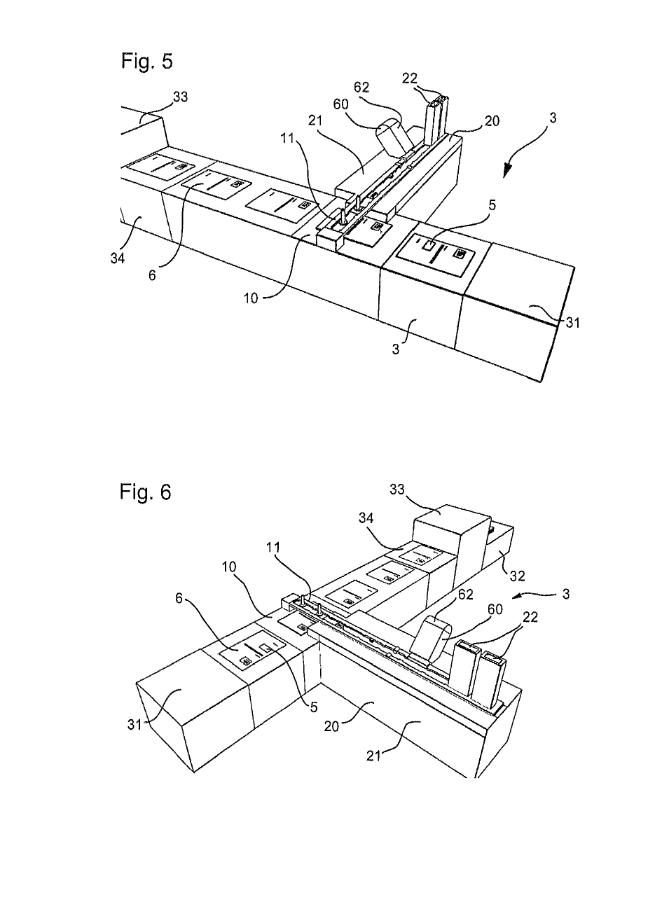

FIG. 6 the arrangement according to FIG. 5 from a different perspective;

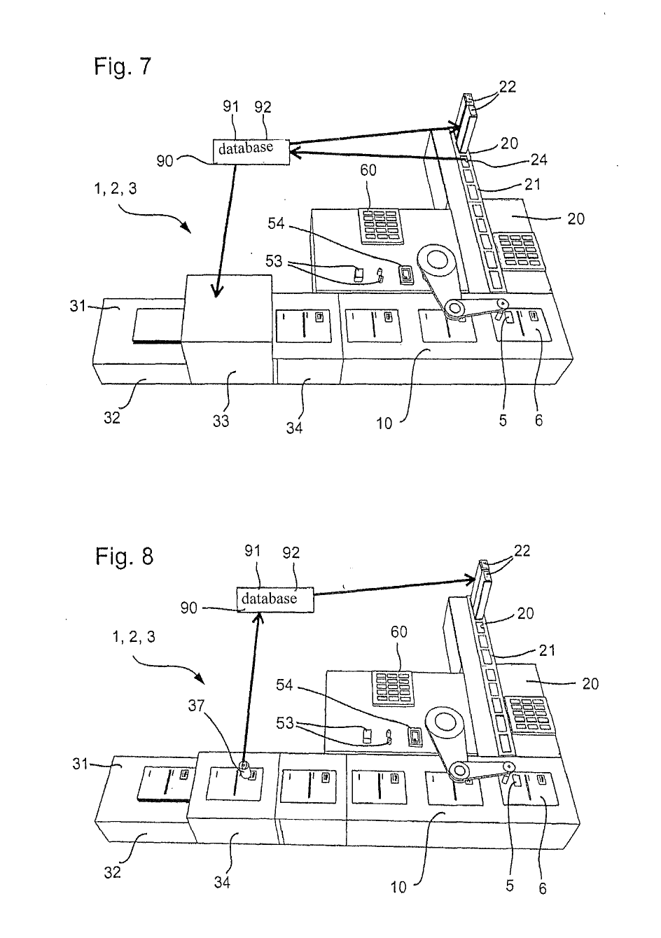

FIG. 7 a further application apparatus with a manipulator in a perspective schematic view and an exemplary representation of a database;

FIG. 8 a further application apparatus with a manipulator in a perspective schematic view and an exemplary representation of a database;

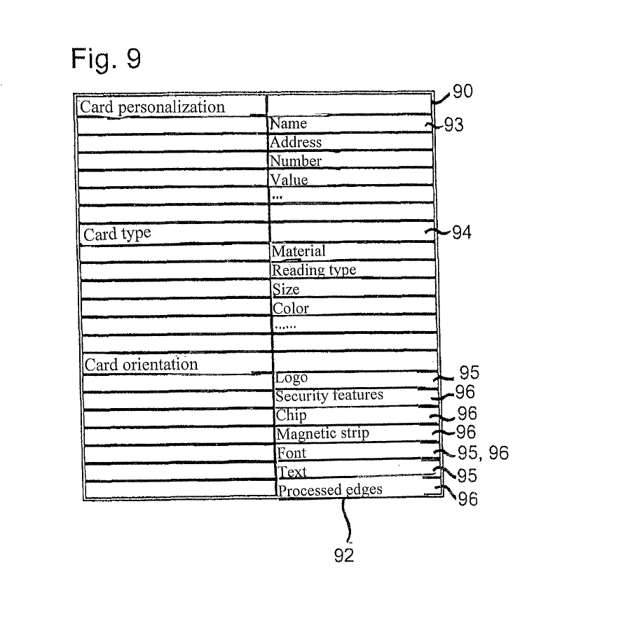

FIG. 9 schematically, allocation of a database;

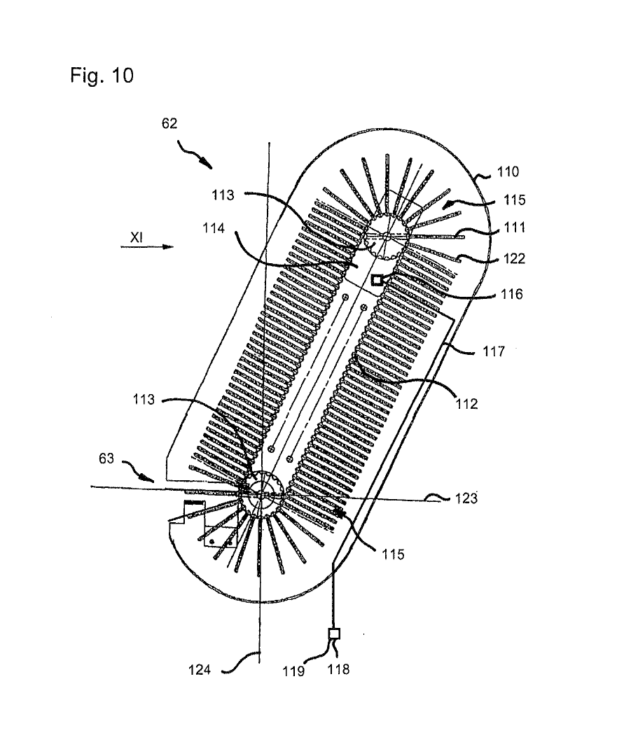

FIG. 10 a section through a card magazine;

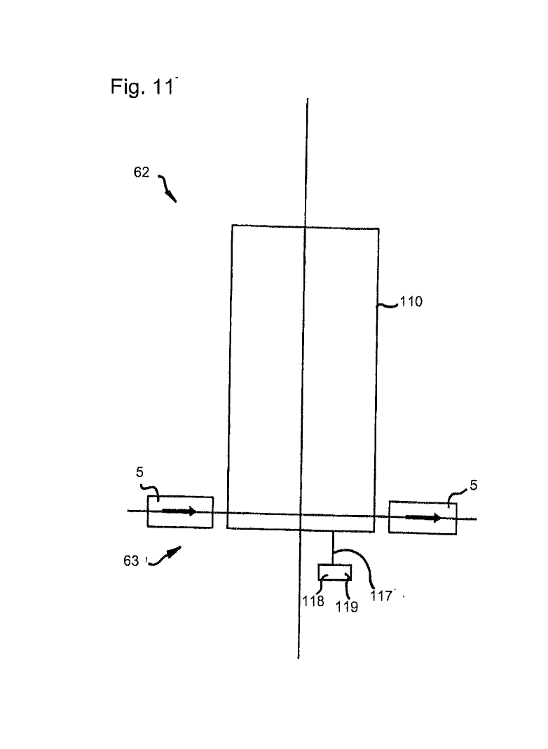

FIG. 11 a schematic front view in the direction of the arrow XI of the card magazine according to FIG. 10;

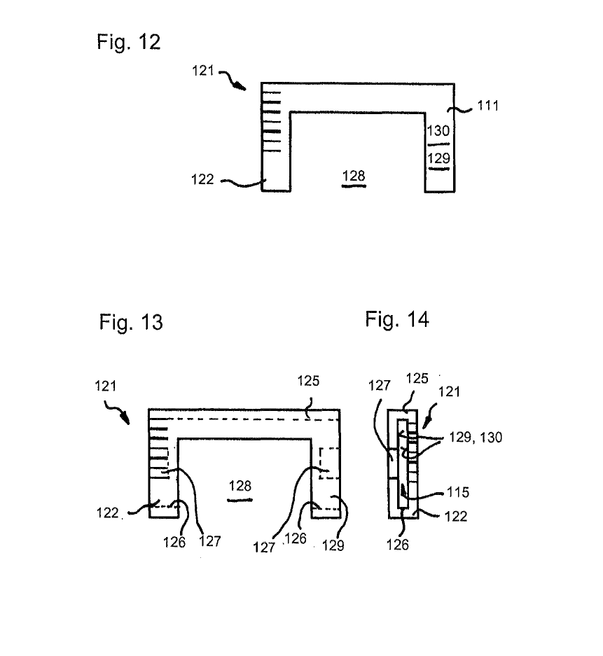

FIG. 12 a top view of a card holder of the card magazine according to FIGS. 10 and 11;

FIG. 13 a top view of an alternative card holder;

FIG. 14 a side view of the card holder according to FIG. 13; and

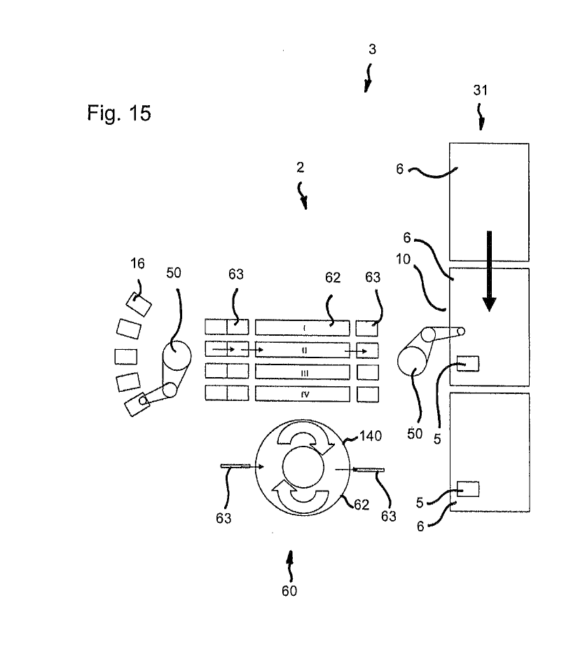

FIG. 15 a top view of further application apparatus.

The handling apparatus 1 or sorting apparatus 2 shown in FIG. 1 comprises a table 26 as a card provisioning unit 20, onto which different cards 5 can be placed in different arrangements. In this connection, these can be, on the one hand, cards 5A with personalized data, cards 5B with magnetic strips, cards 5C with a chip, cards 5D merely imprinted with a picture, or also SIM cards 5E. It is understood that in this regard, other cards can also be processed accordingly.

The handling apparatus 1 or sorting apparatus 2 furthermore has a manipulator 50 with an arm 51, which carries an effector 55 as a horizontal articulated arm robot, with which the cards 5 are grasped and can be set down onto different temporary storage locations 61 of two temporary storage units 60, on the one hand or at output locations 16 of magazines (17) of a card output unit. Also, a card processing station 53 or measurement station 54 in the form of a chip card reading and writing device 7 is disposed in the area of the manipulator 50.

Not shown in FIG. 1 is a camera, which, depending on the concrete embodiment, is set up fixed in place on the table 26 or disposed on the effector 55, so that the cards 5 can be visually recorded and grasped by the manipulator 50 in the desired manner. In this connection, it is also possible to read out possible chip cards by way of the card processing station 53 or measurement station 54, or also to write to them in targeted manner for personalization.

Therefore it is easily possible to pick up cards 5 from the table 26 and to sort them by way of the temporary storage unit 60, in that the card are deposited there, either individually or sorted in stacks. In this connection, the cards can then be given, sorted, to output locations 16, from which they are filled into the magazines 17. The cards can then be removed for further processing purposes in the magazines 17. For example, the cards, which were sorted accordingly, can be supplied to an application apparatus.

In the following figures, the different card types or kinds of cards are no longer labeled individually, for the sake of clarity. Ultimately, the card type or kind of card plays a subordinate role anyway, because if possible, the most varied types of cards 5 are supposed to be handled or sorted accordingly.

As can be directly understood, the manipulator can move to or call on the individual temporary storage locations 61 and thereby address them independently. Because the cards 5 are deposited in the temporary storage unit 61 and can also be removed from there again by the manipulator, this is a reversible temporary storage unit 60.

The handling apparatus 1 or sorting apparatus 2 according to FIG. 2 essentially corresponds to the arrangement according to FIG. 1, so that multiple explanations of identical modules or modules with the identical effect will not be provided. The method of procedure is the same with regard to the following exemplary embodiments, as well.

In deviation from the exemplary embodiment according to FIG. 1, the arrangement according to FIG. 2 comprises two magazines 62 that are configured, purely mechanically, in accordance with the magazines according to WO 2004/039711 A1, as rotating temporary storage units 60. However, these magazines 62 were modified, supplemental to the embodiment according to the state of the art, to the effect that the individual temporary storage locations of these magazines can be individually and independently addressed, so that cards can be removed from specific temporary storage locations in targeted manner and can also be deposited there. In this manner, sorting can take place, particularly by way of the magazines 62, in that the manipulator 50 deposits cards 5 at the inputs and/or outputs 63 of these magazines 62. For further sorting purposes, the arrangement according to FIG. 2 also has a temporary storage unit 60 with temporary storage locations 61 disposed next to one another and in front of or behind one another, as is also provided in the case of the exemplary embodiment according to FIG. 1. In this way, sorting activities can be performed in significantly simpler manner than with the magazines 62. However, one of the plates provided with storage locations 61 in two dimensions is not used as a temporary storage unit as in the exemplary embodiment according to FIG. 1, but rather as a card output unit 15 with multiple output locations 16, from which correspondingly sorted card stacks can then be removed by hand, as needed.

It is understood that the arrangements shown in FIGS. 1 and 2 can also be combined with one another and expanded with further temporary storage units 60 or card processing stations 53 and measurement stations 54, whereby it is already directly evident from the drawing that for this purpose, sufficient room remains in the area of the manipulator 50, so that as a result, a particularly compact embodiment is easily possible, even in the case of a multiplicity of assemblies.

The application apparatus 3 shown in FIG. 3, which accordingly comprises a handling apparatus 1 and a sorting apparatus 2, in turn has a table 26 as a card provisioning unit 20 for cards 5, as was already explained for the exemplary embodiments according to FIGS. 1 and 2. Furthermore, the application apparatus 3 comprises a manipulator 50, within the reach of which, on the one hand, an application area 10 for uniting the cards 5 with card supports 6 and, on the other hand, a temporary storage unit 60 with multiple temporary storage locations 61 disposed in two dimensions relative to one another and multiple processing stations 53 or measurement stations 54 are disposed.

Furthermore, this application apparatus 3 comprises a card support channel 31 with a supply 32 and a measurement station 34, which channel leads to the application area 10, and, proceeding from this, another measurement station 34 for a final inspection. In concrete terms, in this exemplary embodiment the card supports 6 are sheets of paper, which are to be united with the cards 5, whereby accordingly, the processing station 33 is a printer, and the supply 32 is a corresponding printer tray.

The printed sheets of paper are inspected in the measurement station 34, by way of a camera, not shown, and sorted out, if necessary, which makes temporary storage necessary, precisely as needed.

After the inspection, the card supports 6 or the letters are united with the cards 5.

In the exemplary embodiment shown in FIG. 3, a chip card and magnetic strip reader is disposed within reach of the manipulator 50, as the measurement station 54, as are two glue dot dispensers as processing stations 53, so that personalized data in the cards 5, in each instance, can be read out, before the corresponding cards 5 are temporarily stored in the temporary storage unit 60. A corresponding print order is then issued to the printer 33 with the readout, whereby the measurement station 34 once again reports, if a corresponding card support 6 was produced accurately and correctly, that the manipulator 50 removes the correct card 5 from the temporary storage unit 60 and applies it to the related card support 6 in the application area 10. In this manner, a corresponding letter can be produced in extremely individual manner, using the data found on the card. Corruption of the adhesive, of the cards 5 or of other components of the apparatus can be effectively avoided by means of the glue dot dispensers that are used only immediately before application of a card 5.

The arrangement according to FIG. 3 also comprises a card channel 21 that supplies cards from magazines 22 to the application area 10, as a component of the card provisioning unit 20.

In this connection, the cards 5 supplied by way of the card channel 21 correspond to a standard large-series order, whereby personalized data of a card 5 are read by way of a chip and magnetic strip reading apparatus as a measurement station 24, and a corresponding print order is issued to the printer 33. If a correspondingly prepared card support 6 or letter moves past the inspecting measurement station 34 after the printer 33 and is not sorted out, the corresponding card is provided with a glue dot at a processing station 23, and removed from the card channel 21 by means of the manipulator 50, and applied to the corresponding card support 6. If a card support 6 that has already been ordered is sorted out at the measurement station 34, then application by the manipulator 50 does not take place, but rather the card 5, in each instance, is placed into the temporary storage unit 60 without a glue dot. A renewed print order is issued to the printer 33, so that the card is removed from the temporary storage unit 60, provided with a glue dot at the processing station 53, and applied to the corresponding card support 6 if the newly printed card support 6 moves past the measurement station 34 and is not sorted out.

The card provisioning unit 20 furthermore comprises, however, a plate not numbered in detail, which essentially corresponds to the plate of the temporary storage unit 60, so that here, individual cards can easily be set down, which cards the manipulator 50 can then pick up as needed. In this connection, these cards can be read in and recognized by way of the processing station 53, if necessary, so that a database can undertake a corresponding assignment.

In an alternative implementation, it can be necessary to manually report the cards 5 laid down manually by way of the plate of the card provisioning unit 20, for example by way of a suitable computer terminal, to the database or the corresponding process controller.

Furthermore, this arrangement can slightly differently from the methods of procedure listed above, because it can be assumed that the corresponding total order was previously preconfigured to a sufficient degree. This means that not only the printer 33 but also the card channel 21 works with the magazine 22 according to firmly predetermined and prepared orders. A corresponding inspection takes place by way of the measurement stations 24 and 34, and this is reported to the database 90, which then activates the manipulator 50 accordingly. A separate order is issued for cards 5 sorted out by the manipulator 50, similarly as for the cards 5 set down manually by way of the plate of the card provisioning unit 20, which order is then started by way of the printer 33, and the database 90 and, by way of the latter, the manipulator 50 are activated in suitable manner. It is understood that in this regard, different method management, particularly also the method management as it is explained above or for the following exemplary embodiments, can be carried out.

The application apparatus 3 shown in FIGS. 5 and 6 makes use, as such, of a conventional application apparatus, whereby, however, a buffer known from the state of the art has been modified as a temporary storage unit 60 in the form of a magazine 62, in that this unit has been provided with independently addressable storage locations. In this manner, a card situated in the temporary storage unit 60 can be removed from the temporary storage unit 60 again, as needed, and individually supplied, by way of the card channel 21, to the application area 10, in which a conventional applicator 11 for the cards is provided. In this regard, the related cards 5 for the card support 6, in each instance, can be requested, in targeted manner, from the storage unit 60, for example by means of the measurement station 34, which reads out personalized data of the corresponding card support 6. Likewise, cards 5, for which no card support 6 is available in timely manner, for whatever reason, but which have already been dispensed from the magazine 22, can be temporarily stored in the temporary storage unit 60.

The arrangements shown in FIGS. 7 and 8 essentially correspond to the arrangement according to FIG. 3, whereby here, too, a separate plate that corresponds to the temporary storage unit 60 is used as an additional card provisioning unit 20, so that here, an arrangement similar to the arrangement shown in FIG. 3 is present, and the plate of the card provisioning unit 20 is merely disposed at a different location.

In the exemplary embodiment shown in FIG. 7, the database 90 controls the magazines 22 directly, and thereby sets the basic rhythm of the application apparatus 3 according to FIG. 7. The card 5 ultimately output by the magazine 22 is reported to the database by way of the measurement station 24, which was already explained in detail above, and the database then issues a corresponding print order to the printer 33, so that the corresponding card 5 and the related card support 6 can be united accordingly.

In the event of possible malfunctions, the cards are placed in the temporary storage unit 60, as already explained in detail above, and a renewed print order is issued.

Individual cards can be supplied to the method by way of the plate of the card provisioning unit 20, whereby these are then read into the measurement station 54, accordingly, and reported to the database 90, so that the latter can issue a corresponding print order.

In the exemplary embodiment shown in FIG. 8, no printer 33 is provided in the card support channel 31. In this exemplary embodiment, the card supports 6 are made available separately. A card support 6 is checked by way of a camera 37 at the measurement station 34, and a corresponding order for output of a card from the magazine 22 is issued, which cards are then supplied to the application area 10 by way of the card channel 21. Special cards can be made available by way of the separate plate of the card provisioning unit 20, which cards, if necessary—similar to the situation of possible incorrect deliveries from the magazine 22, can also be temporarily stored in the temporary storage unit 60, until a matching card support 6 is available.

In the database 90, as it is presented as an example, particularly in FIGS. 3, 7, and 8, card support data sets 91 and card data sets 92 are present, so that a corresponding data reconciliation can easily be carried out.

In this connection, the card data set 92 has not only personalization data 93 and card type data 94, which is actually known, but also visual data 95 or position data 96, as indicated in FIG. 21 as an example. Likewise, data concerning the kind of card can be stored in the card data set 92, in each instance. By means of a database 90 configured in this manner, it is possible to undertake targeted card orientation in automated manner.

The magazines 62 as such can be structured in different ways. A detailed example of a magazine 62 is represented in FIGS. 10 and 11, and comprises a housing 110, within which a plurality of card holders 111 are provided on a belt 112 that circulates around deflection rollers 113.

In this exemplary embodiment, the upper deflection roller 113 is driven by a drive 114, which in turn can be put into motion and stopped by means of an actuator 116, in desired manner.

The actuator 116 is connected, by way of a line 117, with a signal input 118 and signal output 119 which are implemented, in this exemplary embodiment, by way of a common plug, which also ensures a current or voltage supply.

Furthermore, the actuator 116 is connected, by way of a line, not shown, with an address reading device 120 that reads out addresses that are applied to the card holders 111, which thereby serve as address supports 122, as binary code 121 (see FIG. 12), and passes them on to the actuator 116.

In this connection, the latter is configured in such a manner that the drive 114, similar to a stepper motor, only stops when a card holder 111 is positioned precisely in position with reference to the input and/or output 63, in other words, in this exemplary embodiment, precisely horizontally (horizontal 123), so that card input or card output can take place.

While in the exemplary embodiment shown in FIGS. 10 and 11 the card input or card output takes place laterally, the card output or card input can also take place frontally, as is directly evident, as is indicated as an example in the exemplary embodiment according to FIG. 2.

Card spaces 115 are formed between the card holders 111, which spaces can be unambiguously addressed by means of the codes 121 of the card holder 111 or address supports 122. By means of a suitable selection of the geometric shape of the housing 110, the cards 5 can be prevented from falling out of these card spaces 115.

At greater rotational speeds, the latter can lead to malfunctions or to noises or to damage to the cards 5, which can be avoided by means of a card holder 125 that ultimately forms a card space 115 in itself, and not, as shown in the exemplary embodiment according to FIGS. 22 to 24, in interplay with adjacent card holders 111. The same can also be implemented by means of other measures, such as, for example, slide rails disposed to circulate, holding clamps that circulate, or the like.

In this connection, the card holder 125 also comprises outer contact locations 126, which delimit and define the card spaces 115, particularly radially to the outside. Cards 5 can be pushed into or out of the card spaces 115 at the input and/or output 63, by way of a lateral opening 127, in that corresponding drive devices engage into the openings 127.

It is understood that card holder 111 and address support 122 are not necessarily implemented on identical modules, but rather can also be implemented in different modules.

Both card holders 111 and 125 have a recess 128, in each instance, which is implemented, in these exemplary embodiments, by means of a complete elimination of material at this location, but can also be formed, if necessary, by a correspondingly thinner material layer of the card holder 111, 125 in a corresponding area. In this connection, the recess 128 has a holder edge 129 of the card holder 111, 125, in each instance, at least on two sides, in the present exemplary embodiments actually on three sides, which form a card contact surface 130, in each instance, so that an adhesive location on a card 5 cannot degenerate as quickly in the magazine, in each instance, in the area of the recess 128.

The application apparatus 3 shown in FIG. 15 comprises a sorting apparatus 2 and two manipulators 50, whereby a first manipulator 50 has an application area 10 for uniting cards 5 with card supports 6 within its reach, on the one hand, and a temporary storage unit 60 with multiple magazines 62 and outputs 63, in each instance, on the other hand, while a second manipulator 50 has the inputs 63 that belong to the magazines 62, on the one hand, and multiple output locations 16 of magazines that are not explicitly shown, on the other hand. In this way, sorting work can be performed between the magazines that are not shown, with the output locations 16 and the outputs 63, and the first manipulator 50, using the magazines 62, so that these modules are an integral part of the sorting apparatus 2. It is understood that processing stations 53 or measurement stations 54 and the like can also be disposed within reach of the manipulators 50, if necessary, so that here, too, a handling apparatus can be present, in each instance.

Furthermore, this application apparatus 3 comprises a card support channel 31 that leads to the application area 10. In concrete terms, in this exemplary embodiment the card supports 6 are sheets of paper that are to be united with the cards 5, whereby depending on the concrete implementation of this exemplary embodiment, further stations, as they were already explained above, can also be present.

After sorting, the card supports 6 or the letters are united with the cards 5. In this connection, for example, completely unsorted cards 5 can be made available in the magazines at the output locations 16, which cards are then sorted into the magazines 62 by way of the second manipulator 50 and temporarily stored there. Depending on the demands of the system, the cards 5 stored in the magazines 62 can be made available to the first manipulator 50 at the outputs 63, in any desired sequence, so that the latter can then undertake the application in the desired sequence.

In this connection, it is possible that an entire day's throughput of cards 5 is temporarily stored in the magazines 62.

In this exemplary embodiment, the magazines 62, in each instance, are provided with cardholders disposed in circular manner in a circular card storage unit 140, which rotates, as is indicated in the lower part of FIG. 15. In this connection, it is assumed that a card storage unit 140 configured in this manner permits very high rotation speeds and a great number of card spaces as compared with the card storage unit shown in FIGS. 10 and 11. Also, such an embodiment allows doing without moving belts for conveying the card holders.

Depending on the concrete implementation, the card holders 111 or 125 can also be used, in particular, in the card storage unit 140.

The magazine 62 shown as an example in FIG. 15 has a card storage unit 140 configured as a rigid basic body in this exemplary embodiment, which body, in view of the size of the card storage unit 140, is structured in multiple parts and is composed of individual card holders.

In this connection, the magazine 62 and its card spaces are merely configured in passive manner, in other words these modules, with the exception of a card storage unit, does not enter into any interventions or interactions with the cards. In particular, no sensors or reading and writing devices that read out data of the cards or can save data on the cards, electronically or magnetically, are provided per card space, because construction space is required for this and the mass of the basic body increases, which would be detrimental to the speed and the capacity of the magazine 62 and therefore to the greatest possible storage capacity and low access time, as intended. Also, in this manner, possible electrical feed lines, with their specific disadvantages regarding weight and construction effort, can likewise be avoided.

### REFERENCE SYMBOL LIST

1 handling apparatus
2 sorting apparatus
3 application apparatus
5 card
5A card with personalized data
5B card with magnetic strip
5C card, imprinted only
5D card with picture
5E SIM card
6 card support
7 chip card reading and writing device
10 application area
11 applicator
16 output location
17 magazine
20 card provisioning unit
21 card channel
22 magazine
23 card processing station
24 measurement station
26 table
31 card support channel
32 supply
33 processing station
34 measurement station
35 folding station
37 camera
50 manipulator
51 arm
53 card processing station
54 measurement station
55 effector
60 temporary storage unit
61 temporary storage location
62 magazine
63 input and/or output
71 turner module
90 database
91 card support data set
92 card data set
93 personalization data
91 card type
95 visual data
96 position data
110 housing
111 card holder
112 belt
113 deflection roller
114 drive
115 card space
116 actuator
117 line
118 signal input
119 signal output
120 address reading device
121 code
122 address support
123 horizontal
124 vertical
125 card holder
126 contact location
127 lateral opening
128 recess
129 holder edge
130 card contact surface
140 circular card storage unit

1-23. (canceled)

24. Apparatus for sorting cards (5) being planar, essentially inherently rigid bodies, which are not larger than 10 by 10 cm, i.e. debit cards, credit cards, SIM cards or chips, particularly telephone chips, gift certificate card, or similar cards, with a card provisioning unit (20) and a card output unit (15), comprising a temporary storage unit (60) with addressable temporary storage locations, and a magazine (17), into which cards (5) are placed in a sorted manner.

25. Apparatus according to claim 24, further comprising an industrial manipulator (50) that takes cards (5) from the card provisioning unit (20) and sets them down, sorted, at the card output unit (15), if applicable with use of the temporary storage unit (60).

26. Apparatus according to claim 24, wherein the card provisioning unit (20) is the temporary storage unit (60).

27. Apparatus according to claim 24, further comprising multiple magazines (5) serving as output locations.

28. Apparatus according to claim 24, further comprising a measurement station and/or a card processing station, so that on the one hand, automatic recognition of the card or its orientation and/or, on the other hand, processing, such as personalization, in particular, is possible.

29. Apparatus according to claim 24, wherein said magazine (17) is a stacked magazine.

30. Magazine (62) for cards (5) being planar, essentially inherently rigid bodies, which are not larger than 10 by 10 cm, i.e. debit cards, credit cards, SIM cards or chips, particularly telephone chips, gift certificate card, or similar cards, with at least one input and/or output (63) as well as with a card storage unit that has a plurality of card spaces (115), the card spaces (115) of which can be displaced relative to an input and/or output (63), by means of a drive (114), wherein an absolute or relative address is assigned to each of the card spaces (115), and an actuator (116) activates the drive (114) until an addressed card space (115) is disposed at the input and/or output (63), and wherein said input and/or output (63) individually supplies cards by way of the card channel 21.

31. Card magazine according to claim 30, wherein the actuator (116) has a signal input (118) for indicating a card space address.

32. Card magazine according to claim 30, wherein the actuator (116) has a signal output (119) for indicating when a specific card space (115) is disposed at the input and/or output (63).

33. Card magazine according to claim 32, wherein the indication at the signal output (119) only takes place when the corresponding card space (115) is also accessible by way of the input and/or output (63).

34. Card magazine according to claim 30, wherein an address support (122) that carries a unique address is assigned to each card space (115), and an address reading device (120) is provided in a spatially fixed relation to the drive (114), past which device the address supports (122) run during the relative displacement of the card spaces (115).

35. Card magazine according to claim 34, wherein the actuator (116) has a signal output (119) for indicating when a specific card space (115) is disposed at the input and/or output (63).

36. Card magazine according to claim 30, wherein at least one card holder (111; 125) is assigned to each card space (115), which holder has a recess (128) and a holder edge (129) that surrounds the recess (128) on at least two sides, which edge comprises a card contact surface (130).

37. Card magazine according to claim 36, wherein the actuator (116) has a signal output (119) for indicating when a specific card space (115) is disposed at the input and/or output (63).

38. Method for sorting cards (5) being planar, essentially inherently rigid bodies, which are not larger than 10 by 10 cm, i.e. debit cards, credit cards, SIM cards or chips, particularly telephone chips, gift certificate card, or similar cards, wherein the cards (5) are removed from a card provisioning unit (20) and output, sorted, targeted, and particularly individually, at a card output (15), wherein for sorting, the cards (5) are temporarily stored in a temporary storage unit (60) with independently addressable temporarily storage locations.

39. Method according to claim 38, wherein the cards (5) are output at the card output unit (15) at different output locations (16).

40. Method according to claim 38, wherein the cards (5) are output at the card output unit (15) in multiple magazines (17).
